(19) United States
(12) Patent Application Publication
(10) Pub. No.: US 2007/0130789 A1
(43) Pub. Date: Jun. 14, 2007

(54) Body hair and feet drying chair

(76) Inventors: Chan J. Park, Glenn Dale, MD (US); Myo Sik Park, Glenn Dale, MD (US)

Correspondence Address: LITMAN LAW OFFICES, LTD., P.O. BOX 15035, CRYSTAL CITY STATION, ARLINGTON, VA, 22215, US

(21) Appl. No.: 11/702,185

(22) Filed: Feb. 5, 2007

Related U.S. Application Data
(63) Continuation-in-part of application No. 11/543,965, filed on Oct. 6, 2006.
(63) Continuation-in-part of application No. 11/540,709, filed on Oct. 2, 2006.
Application No. 11/540,709 is a continuation of application No. 10/945,868, filed on Sep. 22, 2004, now Pat. No. 7,117,611.

(51) Int. Cl. F26B 25/06; F26B 19/00

(52) U.S. Cl. 34/202; 34/232; 34/235

(57) ABSTRACT

The body hair and feet drying chair is a seat providing an upright base having a top portion, a middle portion, and a bottom portion, and a hollow interior. A seat is disposed on top of the base. At least one air outlet is defined in the seat in communication with the base's hollow interior. At least one air channel is defined in the bottom portion of the base in communication with the base's hollow interior. A heater and motorized fan is contained within the hollow interior of the base. The fan draws air into the hollow interior through the air channels and expels heated air from the hollow interior through the air outlets. Heated air expelled from the air outlets dries genital and posterior areas of a user seated on the chair, while air drawn into the air channels dries the user's feet and toes.

### CROSS-REFERENCE TO RELATED APPLICATIONS

This application is a continuation-in-part of application Ser. No. 11/543,965, filed on Oct. 6, 2006, which is a continuation-in-part of application Ser. No. 11/540,709, filed on Oct. 2, 2006, which is a continuation of application Ser. No. 10/945,868, filed on Sep. 22, 2004, now U.S. Pat. No. 7,117,611, issued Oct. 10, 2006. The entire disclosure of each of the above-cited related applications is hereby incorporated by reference

### BACKGROUND OF THE INVENTION

1. Field of the Invention

The present invention relates to a human body drying apparatus. More specifically, the invention is a body hair and feet drying chair that circulates air to dry a person's toes and body hair in dampness-prone body areas, especially genital and posterior areas.

2. Description of the Related Art

Damp skin promotes the growth of body-borne fungus, yeasts, and bacteria, often resulting in skin irritation, rash, and other discomforts. Certain areas of the body are especially prone to problems associated with dampness. Areas between the toes, areas surrounding the genitals, and posterior areas around and within the gluteal cleft are prime locations for dampness and the attendant growth of body-borne fungus, yeasts, and bacteria.

A common source of skin dampness is bathing. While regular bathing is necessary for proper personal hygiene, the task of drying oneself after a shower or bath frequently results in incomplete drying, leaving parts of the body damp or wet. The areas between the toes, areas surrounding the genitals, and posterior areas around and within the gluteal cleft are difficult to dry thoroughly with a conventional bath towel. The areas between toes, as well as the posterior areas around and within the gluteal cleft, present a problem of adequate access with a bath towel, while the body hairs surrounding the genitals tend to hold water. Additionally, a natural tendency to sweat after a hot shower or bath ensures that, even with sufficient towel drying, moisture in the form of sweat may quickly reappear.

Air drying apparatus have been used for drying a person's body. Numerous air dryer apparatus have been devised to blow air over a person's body as the person stands in front of, or within, the apparatus. Air, blown over the wet surface of the body, is effective in drying the skin. Additionally, air blown over the skin may have the effect of cooling the body, thereby reducing sweating following a hot shower or bath. However, such apparatus intended for general body drying don't adequately address the special needs of areas between the toes, areas surrounding the genitals, and posterior areas around and within the gluteal cleft.

Air drying apparatus have been incorporated, along with a bidet device, into a toilet to provide for both cleaning and drying of genital and posterior regions. Such apparatus, however, are limited in their use to only the body's genital and posterior regions. Similarly, specialized devices that provide air drying for the feet are ineffective for the rest of the body.

None of the above described apparatus, taken either singly or in combination, is seen to describe the instant invention as claimed. Thus, a body hair and feet drying chair adapted for air drying of areas between the toes, areas surrounding the genitals, and posterior areas around and within the gluteal cleft is desired.

### SUMMARY OF THE INVENTION

The body hair and feet drying chair provides air-drying for a person's toes, including primarily the areas between toes, and skin and body hair in dampness-prone body areas, especially genital and posterior areas, including areas around and within the gluteal cleft. The body hair and feet drying chair has a base portion having a generally hollow interior, there being a motor-driven fan and heating element contained within the hollow interior. A seat is disposed on the top of the base portion. The seat has a rim portion and, centrally located within the rim portion, a depression to accommodate male genitals of a seated user with a minimum of contact with the seat. A plurality of air holes are defined within the seat's depression. The plurality of air holes preferably include air holes having a range of diametric size, ranging from large air holes located in the center of the depression, medium size air holes surrounding the central large air holes, and smaller holes surrounding the periphery of the depression.

A footrest area is defined in a bottom portion of the base. Within the footrest area are air vents, including slotted air vents for drying a user's toes and the areas between toes, and a plurality of smaller air vents distributed generally in a foot-shaped outline to provide additional drying air flow to the user's feet in general.

The motor-driven fan draws air in through the slotted air vents of the foot supports, blowing the air over the heating element and out of the air holes in the seat depression. Thus, a user's toes, and particularly the areas between the toes, are air-dried as air is drawn into the body hair and feet drying chair, while areas surrounding the user's genitals and posterior areas around and within the gluteal cleft are dried by the heated air blowing over the heating element and exiting the body hair and feet drying chair.

The body hair and feet drying chair thus provides drying for body areas that are prone to dampness and difficult to adequately dry, and are, therefore, subject to fungal and bacterial infections. While improved drying may not fully cure such infections, it significantly helps to reduce the risk of becoming infected.

These and other features of the present invention will become readily apparent upon further review of the following specification and drawings.

### BRIEF DESCRIPTION OF THE DRAWINGS

FIG. 1 is an environmental, perspective view of a body hair and feet drying chair according to the present invention.

FIG. 2 is a front view of the body hair and feet drying chair of FIG. 1.

FIG. 3 is a side view of the body hair and feet drying chair of FIG. 1.

FIG. 4 is a top view of the body hair and feet drying chair of FIG. 1.

FIG. 5 is a bottom view of the body hair and feet drying chair of FIG. 1.

FIG. 6 is a front view, partially in section, of the body hair and feet drying chair of FIG. 1.

FIG. 7 is a front view, partially in section, of an alternative embodiment of the body hair and feet drying chair.

FIG. 8 is an exploded perspective view of another alternative embodiment of the body hair and feet drying chair.

Similar reference characters denote corresponding features consistently throughout the attached drawings.

### DETAILED DESCRIPTION OF THE PREFERRED EMBODIMENT

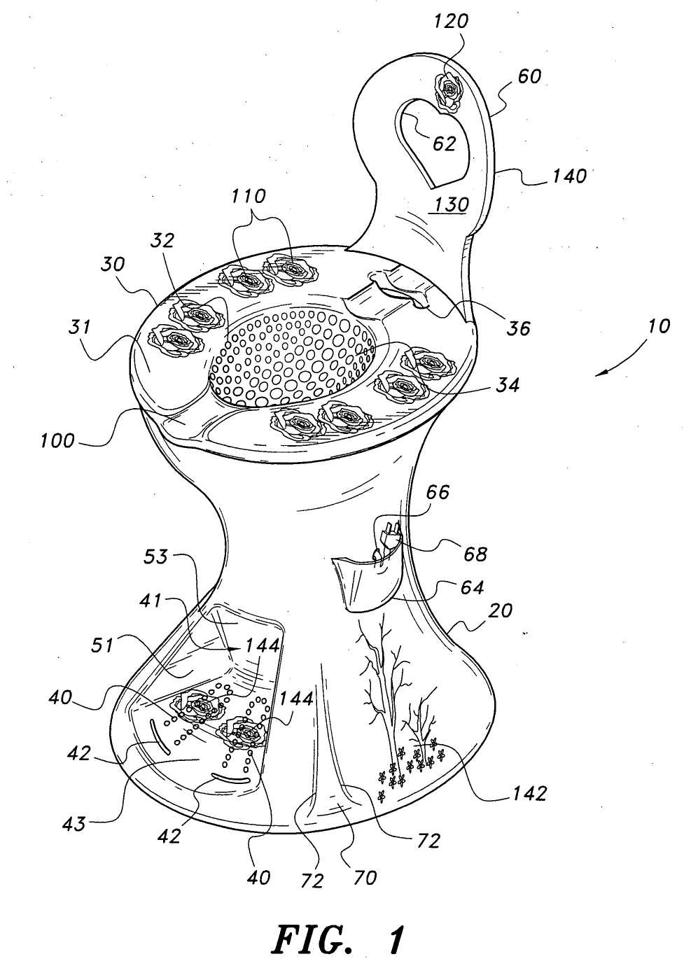

The present invention is a body hair and feet drying chair. Referring to FIG. 1, an embodiment of the body hair and feet drying chair, designated generally as 10 in the drawings, is shown. The body hair and feet drying chair 10 comprises a seat 30 disposed atop an upright base 20, whereby a person can sit comfortably on the body hair and feet drying chair 10. The upright base 20 has a hollow interior, and is generally covered at the top by the seat 30, the bottom being left open.

A plurality of apertures, or air outlets 34, are defined centrally within the seat 30 to allow air blown by a motorized fan within the base 20 to be directed to a seated user's genital areas, body hair surrounding the genitals, and posterior. The air flow directed to these body areas provides a more thorough and complete drying of these body areas than can be achieved by towel drying. An additional air outlet 36 is defined in the seat 30 as a slot near the back of the seat 30. Air expelled from the air outlet 36 is directed to the seated user's lower back, helping to dry the small of the back.

Near the bottom, and on the front side, of the base 20, air channels 42 are defined through the base 20, the air channels 42 being slots having a length that is approximately the same as the width of the toes of a typical human foot. A pair of air channels 42 are shown in the illustrated embodiment, one air channel 42 for each of a user's feet. Alternative configurations of the air channels 42 may be used, including a single air channel 42 having a sufficient width to accommodate both of a user's feet, or multiple smaller air channels 42 for each foot. Additional air channels 40 are small apertures arranged in the outline of a foot, to increase the drying coverage for the entire foot. A seated user places her feet on the base 20 such that her toes overlie the air channels 42, the rest of her foot overlying the air channels 40. As the motorized fan within the base 20 blows air out through the air outlets 34 and 36, air is drawn into the base 20 through the air channels 42. Thus, air is drawn around the seated user's toes and feet, thereby drying the toes and feet, and in particular the regions between the toes.

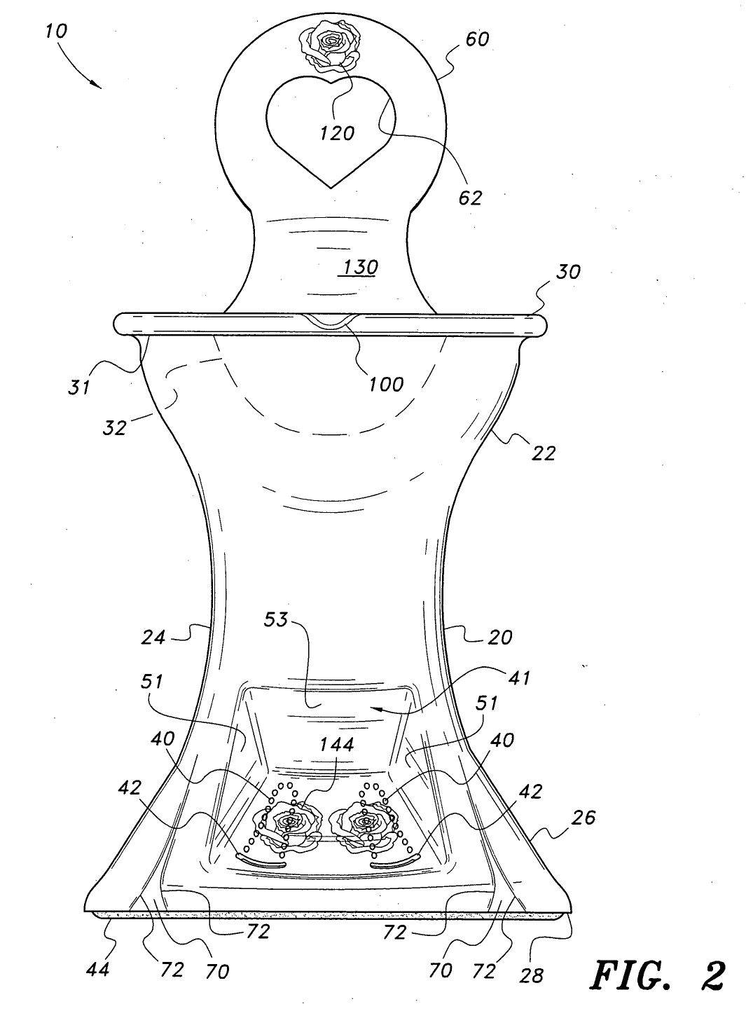

As shown in FIGS. 1 and 2, a footrest area 41 is defined in the base 20, the foot rest area 41 being a depression having a floor 43, a pair of sidewalls 51 and a back wall 53 positioned for comfortable placement of the user's feet and positioning of the user's legs. The air channels 40, 42, are formed through the floor 43 of the footrest area 41. The footrest area 41 provide guidance to the user for proper placement of the feet on the body hair and feet drying chair 10 for best drying of the toes. Alternatively to the single footrest area 41 illustrated, a pair of smaller footrests, one for each of a user's feet, may be used.

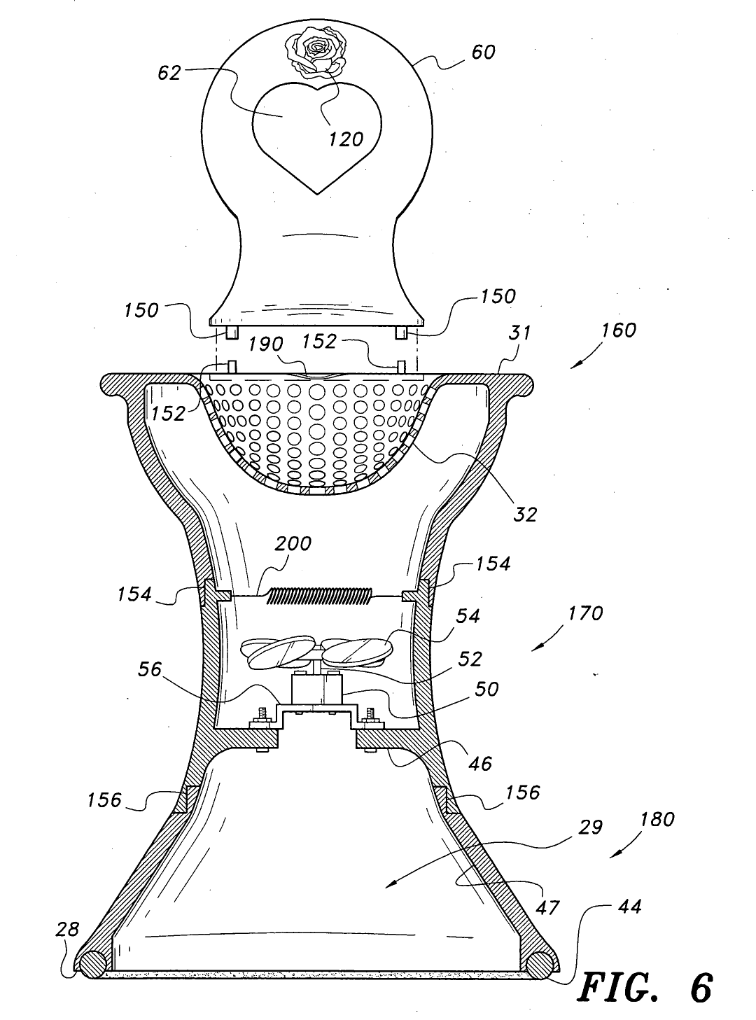

A seat back 60 is provided for comfort. The seat back 60 may be formed integrally with the seat 30 or base 20, or may be removably attached to either the seat 30 or base 20. An opening 62 through the seat back 30 allows improved air circulation in the region of the user's back, promoting improved air drying of the user's back. In FIG. 6, the seat back 60 is shown as having a pair of receiving members 150 provided along the lower edge thereof for releasably receiving engaging members 152 mounted on the seat 30. It should be understood that seat back 60 may be releasably joined to seat 30 through any suitable means for releasable attachment.

Further, as illustrated in the drawings, a forward channel 100 and a rear channel 190 may be formed in an upper surface of the rim portion of the seat 30, allowing for the free passage of air therethrough.

A pocket 64 may be formed on either side, or on each side, of the base 20. Each pocket 64 may be used to hold accessories, magazines, or the like. Additionally, a power cord 68, providing electrical power to the motorized fan and heating element within the base 20, may be stowed within a pocket 64. An aperture 66 is formed through each side of the base 20, and may be located within a pocket 64 so that the apertures 66 are somewhat hidden. The electrical cord is extended from the base 20 through one of the apertures 66. The power cord 68 is extended through one of the apertures 66 on the side of the base 20 most convenient to an electrical outlet. An unused aperture 66 may be covered with a piece of tape or the like to prevent air entry, thereby improving the drying air flow through the body hair and feet drying chair 10.

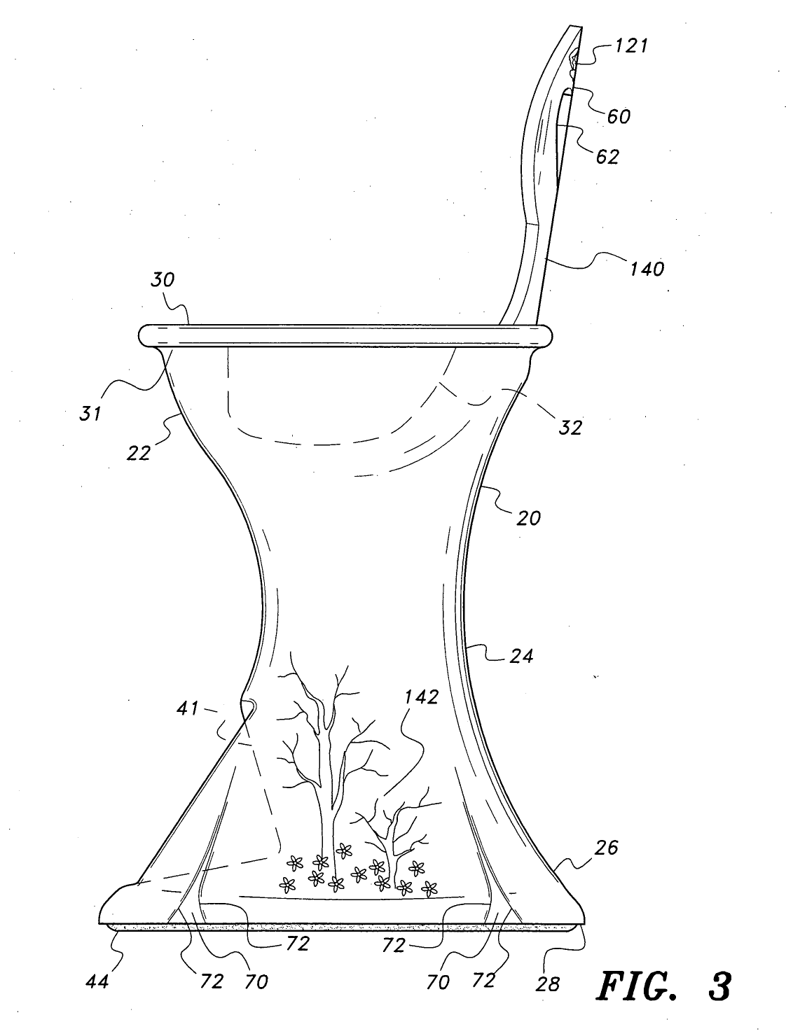

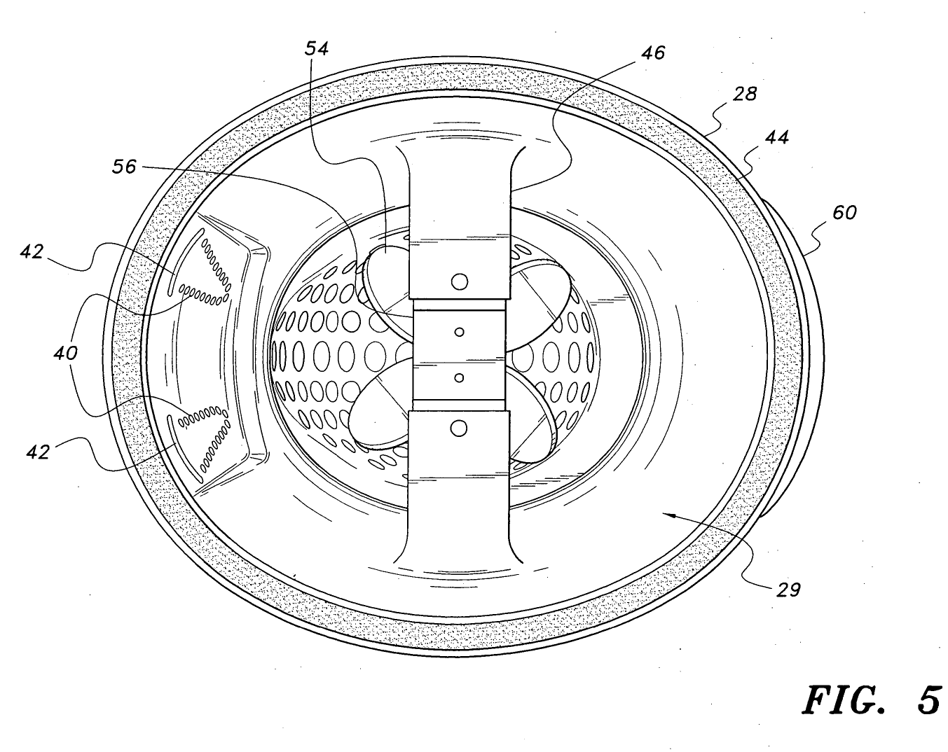

Referring now to FIGS. 1-3, it can be seen that the base 20 has a somewhat hourglass shape, having a widened bottom portion 26, a relatively narrow middle portion 24 and a widened top portion 22. The base 20 has an open bottom 29, surrounded by a bottom edge 28 (seen in FIGS. 5 and 6). The seat 30 is disposed atop the widened top portion 22 of the base 20. A center region 32 of the seat 30 is formed into a concave depression to accommodate male genitals of a seated user with a minimum of contact with the seat 30. The portion of the seat 30 surrounding the center region 32 is referred to as a rim portion 31 of the seat 30. The air outlets 34 are confined to the center region 32 of the seat 30, while the air outlet 36 is located along the rear periphery of the rim portion 31 of the seat 30.

The air channels 40 and 42, and the coincident footrest area 41, are defined in the front of the bottom portion 26 of the base 20. The front of the bottom portion 26 of the base 20 may be contoured or extended forward to provide for the comfortable placement of a user's toes and feet over the air channels 40 and 42.

A rubber O-ring 44 is disposed along the bottom edge 28 of the base 20. The O-ring 44 provides an air seal between the bottom edge 28 of the base 20 and the floor, ensuring that air is drawn into the base 20 through the air channels 40 and 42, rather than through spaces between bottom edge 28 and a floor, as might result if the body hair and feet drying chair 10 is used on an uneven floor surface. Additionally, the O-ring 44 provides protection to the floor surface against damage or abrasion caused by the body hair and feet drying chair 10.

The bottom portion 26 of the base 20 is strengthened by a plurality (four in the illustrated embodiment) of small valleys 70 defining broad ridge areas 72, giving the bottom portion 26 of the base 20 somewhat of a stylized four-leafed clover or flower petal appearance. In addition to creating a stylized appearance, the valleys 70 and ridge areas 72 help to distribute weight forces and minimize the development of small cracks in the base 20.

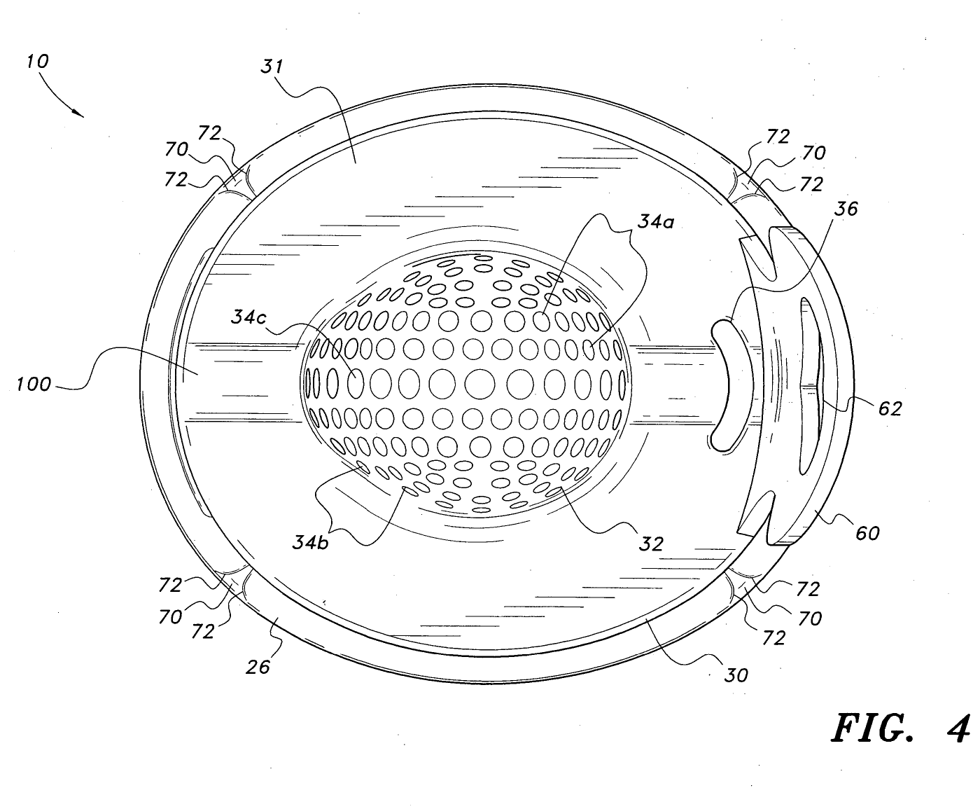

Turning now to FIG. 4, the arrangement of air outlets 34 and 36 is best shown. The air outlets 34, defined within the center region 32 of the seat 30, include large air outlets 34c centrally located within the center region 32 of the seat 30. Surrounding the large air outlets 34c are medium air outlets 34a, the medium air outlets 34a being surrounded by small air outlets 34b at the periphery of the center region 32 of the seat 30. The decreasing size of the air outlets 34 from the center to the periphery of the center region 32 of the seat 30 helps to direct the airflow, concentrated more centrally within the seating area, toward the genital and posterior areas of a user's body. The air outlet 36 is located in the seat 30 outside the center region 32 to provide a drying airflow generally toward the small of a seated user's back.

Turning now to FIGS. 5 and 6, open bottom of the base 20 can be seen, with the O-ring 44 disposed along the bottom edge 28 of the base 20. It can be seen that an electric motor 50 is disposed generally within the middle portion 24 of the base 20. Support arms 46 extend from an interior surface 47 of the base 20 to support a motor mounting bracket 56. The electric motor 50 is mounted on the bracket 56. A shaft 52 of the electric motor 50 turns a fan 54, the airflow being directed upward so that air is drawn into the base 20 through the air channels 40 and 42, and out from the base 20 through the air outlets 34 and 36.

As an alternative to the open bottom 29, employing O-ring 44 to form an air seal against a floor surface, the bottom of the body hair and feet drying chair 10 may be closed, obviating the need for the O-ring 44. However, with an open bottom 29, the body hair and feet drying chair 10 may be placed over a floor heating vent to provide a source of heated air. In another embodiment, the motorized fan may be eliminated, the body hair and feet drying chair 10 relying entirely on air expelled from a floor vent, the air entering the hollow interior of the body hair and feet drying chair 10 through the open bottom 29 and exiting both the air outlets 34, 36 and the air channels 40 and 42.

As shown in FIG. 6, a heater or heating element 200 is preferably mounted adjacent motorized fan 54 for selectively heating the air driven upwardly by the fan 54. Although shown as being a conventional heating coil, it should be understood that this is for exemplary purposes only, and that heater or heating element 200 may be any suitable air heater. Similar to motorized fan 54, heater 200 may be in communication with an external power supply through any suitable means (such as a conventional household appliance electrical cord or the like, for example). Heater 200 may be mounted through any suitable means of securement.

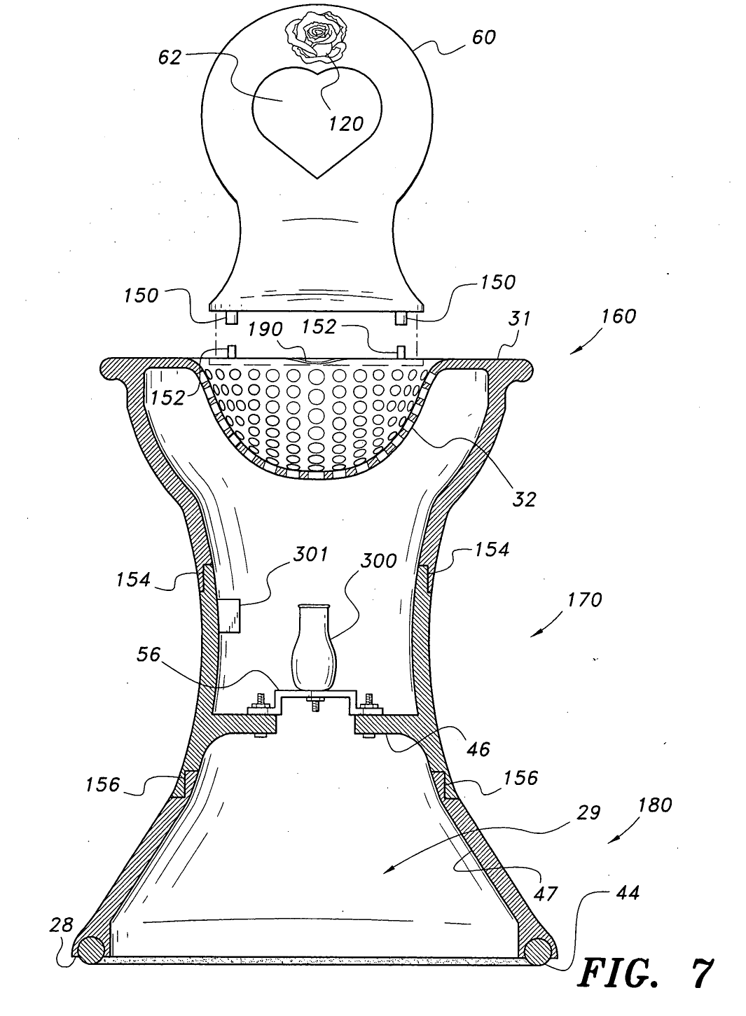

In the alternative embodiment of FIG. 7, the heater element 200 and motorized fan 54 are mounted within a housing, shown (for exemplary purposes) as a conventional hair blow dryer-type housing 300 in FIG. 7. The housing of blow dryer 300 is mounted to bracket 56, in a manner similar to that of the embodiment of FIG. 6.

Further, as shown in FIG. 7, both the motorized fan 54 and the heater element 200 are preferably in communication with control means 301. Control means 301 may be any suitable means for controlling power to motorized fan 54 and heater 200, and further for controlling the power output of both motorized fan 54 and heater 200. Control means 301 may further include a user-programmable timer for the controlled generation of heated air over a user-selectable time period.

In the embodiments of FIGS. 6 and 7, the system is preferably provided as a first portion 160 mounted on a second portion 170, which is further mounted on a third portion 180, with the first, second and third portions being selectively and releasably separable from one another (shown by exemplary division lines 154, 156). Thus, when it is necessary to remove or replace heater 200, motorized fan 54, blow dryer 300 or any other elements of the system, the user may separate portions 160, 170 and 180, each from the other, providing access to the interior of the system. First, second and third portions 160, 170 and 180 may be releasably attached to one another in any suitable manner or through any suitable means, e.g., a snap fit or friction fit.

As shown in FIGS. 1-3, user-selectable indicia 120, 121 are formed, respectively, on the front face 130 and rear face 140 of the backrest portion. Although shown as having a floral design, it should be understood that this is shown for exemplary purposes only, and that indicia 120, 121 may have any desired design appearance. Additionally, indicia 110 may be formed on the rim portion of the seat, indicia 144 may be formed on the footrest portion, and indicia 142 may be formed on the base, as shown. As with indicia 120, 121, indicia 110, 144 and 142 may have any desired user-selectable appearance, including, for example, flowers, trees, mountains, or any other design appearance. The indicia may be applied to any exterior surface of the chair or molded into the surface to appear as a relief or depression in the chair. The indicia may be formed through any desired suitable method. Further indicia may be added to the chair 10, as desired.

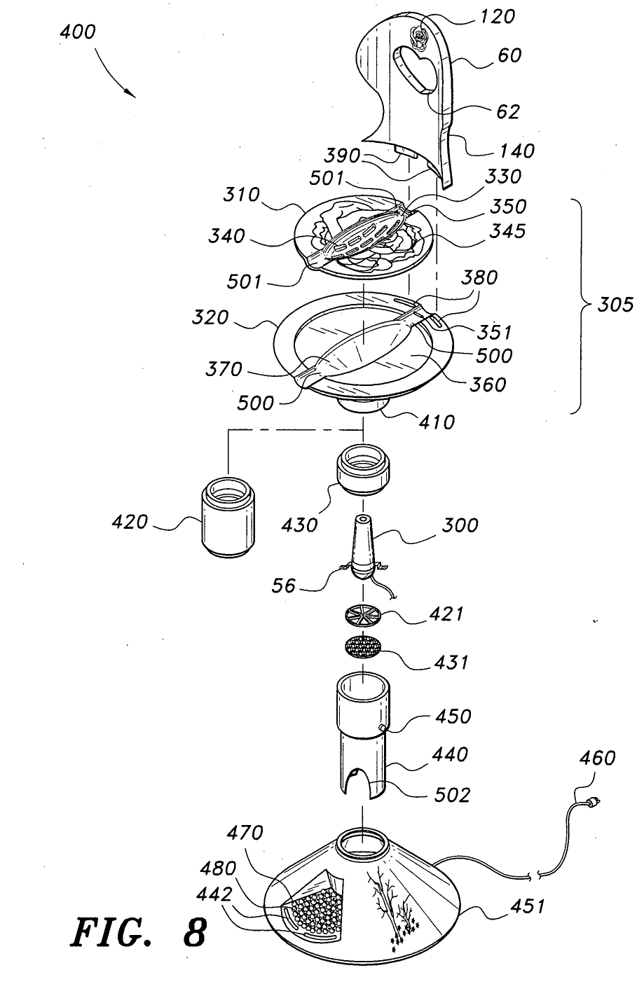

In the embodiment of FIG. 8, the chair 400 includes a seat back 60, similar to that described above with respect to the earlier embodiments, having a pair of engaging members 390 extending from a lower edge thereof. The integral, one-piece seat portion 30 of FIG. 2 is replaced in the chair 400 by seat portion 305, which includes a lower portion 320 having a recessed central disk 360 formed therein, and a tray 310 that is removably and releasably received within recessed disk 360. Forward and rear channels 500 are preferably formed in lower portion 320, as shown, along with forward and rear channels 501 being formed in tray 310. These forward and rear channels are similar in contouring and function to forward and rear channels 100,190 of the previous embodiments.

Tray 310 has a centrally located recess 330 (similar to depression 34 in FIG. 2) surrounded by a rim portion. The rim portion includes a decorative region 345, which preferably has a floral design, as shown. Unlike the two-dimensional indicia 110 of FIG. 1, the decorative region 345 is preferably formed with three-dimensional relief, providing a massage surface for the user's buttocks. Further, air passages 350, 351 are preferably formed through the rear portions of tray 310 and lower portion 320, as shown, with passages 350, 351 being aligned with one another, as illustrated in FIG. 8.

The rear portion of the rim of lower portion 320 has a pair of slots 380 formed therethrough for releasably receiving the engaging members 390 of seat back 60. The lower portion 320 has a central disk 360 recessed below the rim, the central disk 360 having a hole 370 defined therein, so that tray 310 is supported on the central disk 360 with the centrally located recess 330 extending through hole 370. The bottom of the lower portion 320 tapers inward in the manner of a funnel to form a hub 410 depending from the lower portion 320 of the seat 305.

The seat portion 305 is supported by a columnar pedestal. The pedestal is formed by a plurality of pipes or tubes 420, 430, and 440 extending upward from a hollow, frustoconical pedestal stand 451. Upper pipe 420 engages hub 410, and lower pipe engages pedestal stand 451. The height of the chair 400 may be adjusted through the use of one or more adapter or intermediate pipes 430 of varying height that may be inserted into or removed from the column to adjust for the height of the user. Pipes 420, 430, and 440 may be connected to each other and to hub 410 and pedestal stand 451 in any suitable manner, e.g., by a neck portion at one end of a pipe that telescopes into the end of the pipe immediately above or immediately below, by threaded joints, etc.

Lower portion 320 of seat 305 has a central opening or hole 370 formed therethrough, which is in open fluid communication with the openings 340 formed through tray 310 (located at the base of recess 330), and with centrally formed passages formed through pipes 420, 430.

Pipes 420, 430 are mounted to lower pipe 440, which houses blower 300 (containing a heater element 200 and fan 54 as described above) and associated accessories, such as rotating grid element 421 and air filter 431. A switch 450 for operating blower 300 may be mounted on lower pipe 440, as shown. The bottom portion of lower pipe 440 is inserted into and seated in a central bore defined in the pedestal stand 451, although not extending to the bottom of the pedestal stand 451 so that air can circulate from the footrest through the pedestal stand 451 and the lower pipe 440 to the blower unit 300 containing the heater 200 and fan 54. Lower pipe 440 preferably includes an opening 502 formed along its lower end, as shown, allowing for fluid communication between the interior of lower pipe 440 and the foot receiving recess of base 451.

The footrest is the front, foot receiving recess of base 451 and has a plurality of massaging beads 470 or other contoured elements (dependent upon the particular needs and desires of the user) formed therein. A plurality of air flow openings 480 are formed between the beads 470, as shown, allowing for the drying of the user's feet. Further, a pair of air channels 442, similar to channels 42 of the previous embodiments, are formed through the lower wall for enhancing air flow therethrough. An electrical cord 460 connected to heater blower 300 may extend from the pedestal stand 451. It will be understood that the bottom edge of pedestal stand 451 may have a rubber O-ring disposed around its peripheral edge to provide a seal with the floor in the same manner as the embodiments of FIGS. 1-7.

As shown, blower 300 is mounted to the interior of lower pipe 440 by a bracket 56, similar to the earlier embodiments, though it should be understood that blower 300 may be fixed in any conventional manner. Air filter 431 is provided to remove bacteria, viruses, pollen, mildew, dust, allergens and the like from the air entering the drying chair. Air filter 431 may be any suitable air filter, dependent upon the particular needs and desires of the user.

It is to be understood that the present invention is not limited to the embodiment described above, but encompasses any and all embodiments within the scope of the following claims.

We claim:

1. A body hair and feet drying chair, comprising:
an upright base having a top portion, a middle portion, and a bottom portion, the upright base having a hollow interior, an open bottom, and a bottom edge surrounding the open bottom;
a rubber O-ring disposed along said bottom edge of said open bottom, said rubber O ring configured to provide a seal between said bottom edge and a floor surface;
a seat disposed on the top portion of said base, the seat having a central concave portion and a rim portion, the rim portion surrounding the central concave portion, the central concave portion having a plurality of air outlets defined therein, the plurality of air outlets being in communication with the hollow interior of said base;
a footrest defined in the bottom portion of said base, said footrest formed as a depression in said base bottom portion, said footrest including a footrest floor, a pair of sidewalls and a back wall, said footrest floor including a plurality of air channels comprising apertures, each of said air channels being in communication with the hollow interior of said base;
a motorized fan disposed within the middle portion of the hollow interior of said base, the motorized fan being arranged and configured to draw air into the hollow interior through said plurality of air channels in said footrest floor and to expel air from the hollow interior through said plurality of air outlets in said central concave portion of said seat; and,
a heater positioned within the middle portion of the hollow interior of said base, adjacent said motorized fan to heat the air expelled from the hollow interior through said plurality of air outlets.

2. The body hair and feet drying chair as recited in claim 1, wherein said upright base has a substantially hourglass shape having a widened bottom portion, a relatively narrow middle portion and a widened top portion.

3. The body hair and feet drying chair as recited in claim 1, wherein said air outlets in said central concave portion of said seat include large air outlets centrally located within the central concave portion, medium air outlets surrounding the large air outlets, and small air outlets at the periphery of the central concave portion.

4. The body hair and feet drying chair as recited in claim 1, further including a plurality of support arms extending inwardly from an interior surface of the base middle portion, said plurality of support arms supporting a motor mounting bracket, said motorized fan being mounted on said motor mounting bracket.

5. The body hair and feet drying chair as recited in claim 4, further comprising a housing, said motorized fan and said heater being mounted within said housing.

6. The body hair and feet drying chair as recited in claim 1, further including an additional air outlet located in and disposed through the rear periphery of the rim portion of said seat.

7. The body hair and feet drying chair as recited in claim 1, further including a seat back extending upwardly from said seat.

8. The body hair and feet drying chair as recited in claim 7, wherein said seat back is releasably joined to said seat.

9. The body hair and feet drying chair as recited in claim 1, further comprising means for selectively controlling said motorized fan.

10. The body hair and feet drying chair as recited in claim 9, further comprising means for selectively controlling said heater.

11. The body hair and feet drying chair as recited in claim 1, further comprising user-selectable indicia formed on said body hair and feet drying chair.

12. The body hair and feet drying chair as recited in claim 1, wherein the rim portion of said seat has a forward channel formed in an upper surface thereof.

13. The body hair and feet drying chair as recited in claim 12, wherein the rim portion of said seat further has a rear channel formed in the upper surface thereof.

14. A body hair and feet drying chair, comprising:
a seat having a tray and a lower portion, the tray having a rim and a central recess surrounded by the rim, the recess having a plurality of air openings defined therein, the lower portion having a rim and a central disk having a hole defined therein, the tray being removably seated on the lower portion with the recess extending through the hole, the lower portion having a hub depending therefrom;
a hollow frustoconical pedestal stand having a central bore defined therein and a footrest defined in the pedestal stand, the footrest being formed in the pedestal stand having a footrest floor and a plurality of apertures forming air channels in the footrest floor, each of the air channels communicating with the hollow bore;
a plurality of hollow pipes extending between the lower portion of the seat and the pedestal stand, the plurality of pipes including a lower pipe seated in the central bore, an upper pipe removably attached to the hub, and at least one intermediate pipe removably disposed between the lower pipe and the upper pipe for adjusting the height of the seat; and
a blower having a heater element and a fan, the blower being disposed within the lower pipe and oriented to draw air from the air channels in the footrest into the pedestal stand and the lower pipe, heat the air, and blow the heated through the plurality of pipes and air openings in the seat tray in order to dry feet and body hair of a person sitting on the seat with the feet disposed in the footrest.

15. The body hair and feet drying chair according to claim 14, further comprising a rubber O-ring disposed along a bottom edge of the pedestal stand, the O-ring being configured to form a seal between the bottom edge and a floor surface.

16. The body hair and feet drying chair according to claim 14, further comprising a seat back removably attached to the rim of the lower portion of said seat.

17. The body hair and feet drying chair according to claim 14, further comprising three-dimensional decorative relief formed on the rim of the lower portion of the seat for massaging buttocks of the person sitting on the seat.

18. The body hair and feet drying chair according to claim 14, further comprising a plurality of beads formed on the footrest floor for massaging the feet of the person sitting on the seat.

19. The body hair and feet drying chair according to claim 14, further comprising an air filter disposed in the plurality of pipes for filtering the air blown up to the seat.

20. The body hair and feet drying chair according to claim 19, further comprising a rotating grid disposed between the air filter and the seat.
